(19) United States
(12) Patent Application Publication
(10) Pub. No.: US 2025/0272910 A1
(43) Pub. Date: Aug. 28, 2025

(54) INFORMATION PROCESSING APPARATUS, INFORMATION PROCESSING METHOD

(71) Applicant: NEC Corporation, Tokyo (JP)

(72) Inventors: Jiro ABE, Tokyo (JP); Gaku NAKANO, Tokyo (JP); Kei SHIBASAKI, Tokyo (JP)

(73) Assignee: NEC Corporation, Tokyo (JP)

(21) Appl. No.: 19/052,344

(22) Filed: Feb. 13, 2025

(30) Foreign Application Priority Data
Feb. 26, 2024 (JP) 2024-026618

(51) Int. Cl. G06T 15/20

(52) U.S. Cl. CPC G06T 15/20

(57) ABSTRACT

Provided is an information processing apparatus including: an acquisition unit configured to acquire three-dimensional point cloud data and a captured image captured by an imaging apparatus under a first imaging condition; a generation unit configured to generate a projection image under a second imaging condition, based on the three-dimensional point cloud data, and generate a pseudo-projection image, based on the projection image and the captured image; and a setting unit configured to set learning data for performing supervised learning by using the pseudo-projection image as an explanatory variable and using the captured image as ground truth data.

### INCORPORATION BY REFERENCE

This application is based upon and claims the benefit of priority from Japanese patent application No. 2024-026618, filed on Feb. 26, 2024, the disclosure of which is incorporated herein in its entirety by reference.

### TECHNICAL FIELD

The present disclosure relates to an information processing apparatus, an information processing method, and a program.

### BACKGROUND ART

Patent Literature 1 discloses a technique capable of accurately estimating three-dimensional coordinates of a subject appearing in a satellite image. In Patent Literature 1, a projection diagram, being a diagram in which a three-dimensional shape represented by three-dimensional data is projected onto a two-dimensional plane along a line-of-sight direction of a sensor, is generated. Then, based on the satellite image, a pseudo-projection diagram in which the projection diagram is pseudo-reproduced is generated. Then, points in the projection diagram and points in the pseudo-projection diagram are associated with each other, and a map in which the points in the pseudo-projection diagram are associated with the points in the three-dimensional shape represented by the three-dimensional data is derived. Then, based on the mapping, an association relationship between a point of an object in the satellite image and a point in the three-dimensional shape represented by the three-dimensional data is derived.

### CITATION LIST

Patent Literature 1: Japanese Unexamined Patent Application Publication No. 2023-177855

### SUMMARY

The technique described in Patent Literature 1 has not been studied for restoring (inferring and restoring) an image to be captured by a camera from a projection diagram (projection image) being a diagram in which a three-dimensional shape represented by three-dimensional data is projected onto a two-dimensional plane along a line-of-sight direction of a sensor.

In view of the problem described above, an example object of the present disclosure is to provide a technique capable of appropriately generating an image to be captured by a camera from a projection image.

In a first example aspect of the present disclosure, provided is an information processing apparatus including: an acquisition unit configured to acquire three-dimensional point cloud data and a captured image captured by an imaging apparatus under a first imaging condition; a generation unit configured to generate a projection image under a second imaging condition, based on the three-dimensional point cloud data, and generate a pseudo-projection image, based on the projection image and the captured image; and a setting unit configured to set learning data for performing supervised learning by using the pseudo-projection image as an explanatory variable and using the captured image as ground truth data.

In a second example aspect of the present disclosure, provided is an information processing method including: acquiring three-dimensional point cloud data and a captured image captured by an imaging apparatus under a first imaging condition; generating a projection image under a second imaging condition, based on the three-dimensional point cloud data, and generating a pseudo-projection image, based on the projection image and the captured image; and setting learning data for performing supervised learning by using the pseudo-projection image as an explanatory variable and using the captured image as ground truth data.

In a third example aspect of the present disclosure, provided is a program for causing a computer to execute processing of: acquiring three-dimensional point cloud data and a captured image captured by an imaging apparatus under a first imaging condition; generating a projection image under a second imaging condition, based on the three-dimensional point cloud data, and generating a pseudo-projection image, based on the projection image and the captured image; and setting learning data for performing supervised learning by using the pseudo-projection image as an explanatory variable and using the captured image as ground truth data.

In a fourth example aspect of the present disclosure, provided is an information processing apparatus including: an acquisition unit configured to acquire first three-dimensional point cloud data; a generation unit configured to generate a first projection image, based on the first three-dimensional point cloud data, and an inference unit configured to infer a second captured image, based on the first projection image, by using a trained model generated by supervised learning using a pseudo-projection image being generated based on a first captured image captured by an imaging apparatus under a first imaging condition and a second projection image under a second imaging condition generated based on second three-dimensional point cloud data, as an explanatory variable, and using the first captured image as ground truth data.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a diagram illustrating one example of a configuration of an information processing apparatus that performs processing of a training phase according to example embodiments;

FIG. 2 is a diagram illustrating one example of a configuration of an information processing apparatus that performs processing of an inference phase according to the example embodiments;

FIG. 3 is a diagram illustrating a hardware configuration example of an information processing apparatus according to the example embodiments;

FIG. 4 is a flowchart illustrating one example of processing of generating training data of the information processing apparatus according to the example embodiments;

FIG. 5 is a diagram illustrating one example of processing of generating training data of the information processing apparatus according to the example embodiments;

FIG. 6 is a diagram illustrating one example of a training data database (DB) according to the example embodiments;

FIG. 7 is a flowchart illustrating one example of processing of generating a trained model of the information processing apparatus according to the example embodiments;

FIG. 8 is a flowchart illustrating one example of processing of an inference phase of the information processing apparatus according to the example embodiments; and

FIG. 9 is a diagram illustrating one example of an application using an inference result according to the example embodiments.

### EXAMPLE EMBODIMENT

The principles of the present disclosure are described with reference to several example embodiments. It should be understood that these example embodiments are set forth for purposes of illustration only and that those skilled in the art will assist in understanding and practicing the disclosure without suggesting limitations on the scope of the disclosure. The disclosure described herein may be implemented in a variety of ways other than those described below.

In the following description and claims, unless otherwise defined, all technical and scientific terms used herein have the same meaning as commonly understood by one of ordinary skill in the art to which this disclosure belongs.

Hereinafter, example embodiments of the present disclosure are described with reference to the drawings. It should be noted that the drawings are merely illustrative of one or more example embodiments. Each drawing may be associated with one or more other example embodiments, rather than only one particular example embodiment. As those skilled in the art will understand, various features or steps described with reference to any one of the figures may be combined with features or steps illustrated in one or more other figures, for example, to create example embodiments not explicitly illustrated or described. All of the features or steps illustrated in any one of the figures to describe the example embodiments are not necessarily essential, and some features or steps may be omitted. The order of the steps described in any of the figures may be changed as appropriate.

### <Configuration>

<<Configuration of an Information Processing Apparatus 10 that Performs Processing of a Training Phase>>

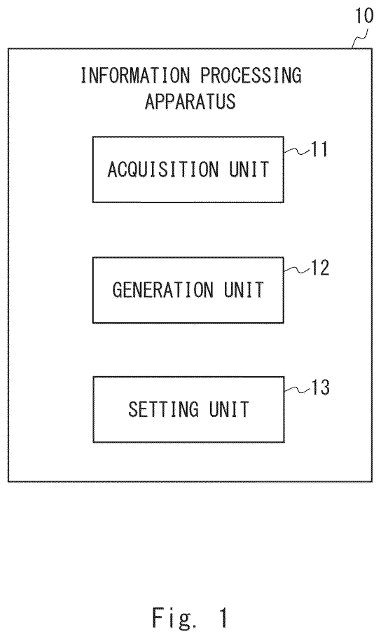

A configuration of an information processing apparatus 10 that performs processing of a training phase according to the example embodiments is described with reference to FIG. 1. FIG. 1 is a diagram illustrating one example of a configuration of the information processing apparatus 10 that performs processing of a training phase according to the example embodiments. The information processing apparatus 10 includes an acquisition unit 11, a generation unit 12, and a setting unit 13. These units may be achieved by cooperation of one or more programs installed in the information processing apparatus 10 and hardware such as a processor and a memory of the information processing apparatus 10.

The acquisition unit 11 acquires three-dimensional point cloud data and a captured image captured at a first point by an imaging apparatus. The generation unit 12 generates a projection image in a specific line-of-sight direction from a second point, based on the three-dimensional point cloud data acquired by the acquisition unit 11, and generates a pseudo-projection image, based on the projection image and the captured image acquired by the acquisition unit 11.

The setting unit 13 sets learning data for performing supervised learning using the pseudo-projection image generated by the generation unit 12 as an explanatory variable and using the captured image acquired by the acquisition unit 11 as ground truth data.

<<Configuration of an Information Processing Apparatus 20 that Performs Processing of an Inference Phase>>

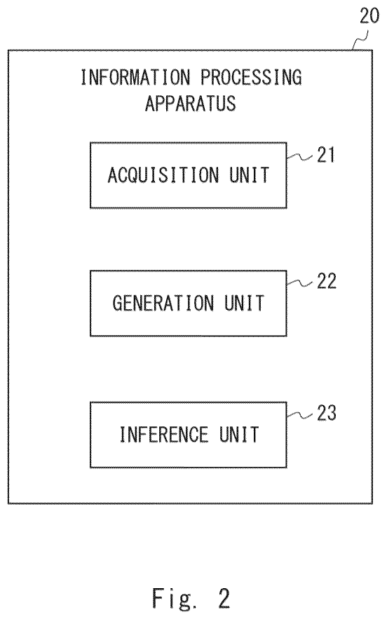

A configuration of an information processing apparatus 20 that performs processing of an inference phase according to the example embodiments is described with reference to FIG. 2. FIG. 2 is a diagram illustrating one example of a configuration of the information processing apparatus 20 that performs processing of an inference phase according to the example embodiments. The information processing apparatus 20 includes an acquisition unit 21, a generation unit 22, and an inference unit 23. These units may be achieved by cooperation of one or more programs installed in the information processing apparatus 20 and hardware such as a processor and a memory of the information processing apparatus 20.

The acquisition unit 21 acquires first three-dimensional point cloud data. The generation unit 22 generates a first projection image, based on the first three-dimensional point cloud data.

The inference unit 23 infers a second captured image, based on the first projection image, by using a trained model generated by the supervised learning using the learning data generated by the information processing apparatus 10. The learning data include a pseudo-projection image, being generated based on a first captured image captured by the imaging apparatus under the first imaging condition and a second projection image under the second imaging condition and generated based on second three-dimensional point cloud data, as an explanatory variable, and includes the first captured image as ground truth data.

### <Hardware Configuration>

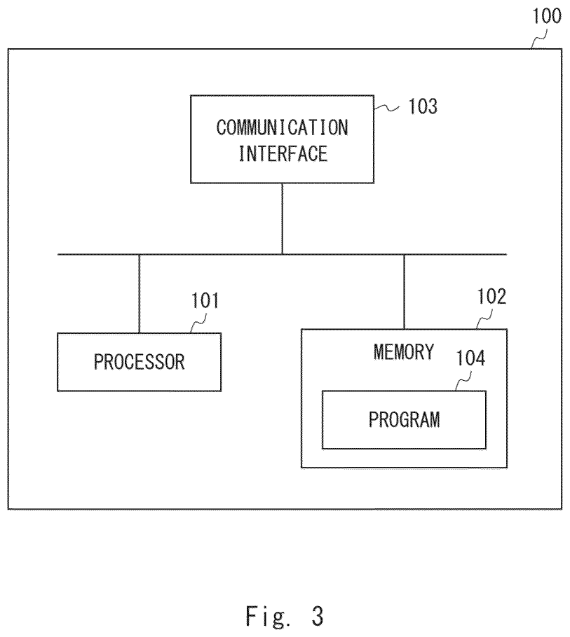

FIG. 3 is a diagram illustrating a hardware configuration example of the information processing apparatus 10 and the information processing apparatus 20 according to the example embodiments. In the example of FIG. 3, the information processing apparatus 10 and the information processing apparatus 20 (a computer 100) include a processor 101, a memory 102, and a communication interface 103. These units may be connected to one another by a bus or the like. The memory 102 stores at least part of a program 104. The communication interface 103 includes an interface necessary for communication with other network elements.

When the program 104 is executed by the cooperation of the processor 101 and the memory 102, for example, the computer 100 performs processing of at least a part of the example embodiments according to the present disclosure. The memory 102 may be of any type. The memory 102 may be, by way of non-limiting example, a non-transitory computer-readable storage medium. Further, the memory 102 may also be implemented using any suitable data storage technology, such as semiconductor-based memory devices, magnetic memory devices and systems, optical memory devices and systems, fixed memory and removable memory, and the like. Although only one memory 102 is illustrated in the computer 100, there may be several physically different memory modules in the computer 100. The processor 101 may be of any type. The processor 101 may include one or more of a general purpose computer, a special purpose computer, a microprocessor, a digital signal processor (DSP), and, as non-limiting examples, a processor based on a multi-core processor architecture. The computer 100 may include a plurality of processors, such as application specific integrated circuit chips being temporally dependent on a clock that synchronizes the main processor.

The example embodiments according to the present disclosure may be implemented in hardware or dedicated circuitry, software, logic, or any combination thereof. Some aspects may be implemented in hardware, while other aspects may be implemented in firmware or software that may be executed by a controller, microprocessor, or other computing apparatus.

The present disclosure also provides at least one computer program product tangibly stored on a non-transitory computer-readable storage medium. The computer program product includes computer-executable instructions, such as instructions contained in a program module, and is executed on a device on a real or virtual processor of interest to perform the processes or methods according to the present disclosure. The program modules include routines, programs, libraries, objects, classes, components, data structures, etc., that perform particular tasks or implement specific abstract data types. The functionalities of the program modules may be combined or split between the program modules as desired in various example embodiments. Machine-executable instructions of the program modules may be executed in a local or distributed device. In a distributed device, the program modules may be located on both local and remote storage media.

Program codes for performing the method according to the present disclosure may be written in any combination of one or more programming languages. The program codes are provided to a processor or controller of a general purpose computer, special purpose computer, or other programmable data processing apparatus. When the program code is executed by a processor or controller, functions/operations in the flowcharts and/or implementing block diagrams are performed. The program code is executed entirely on the machine, executed partly on the machine, as a stand-alone software package, executed partly on the machine and partly on a remote machine, or executed entirely on the remote machine or server.

The program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

### <Processing>

### <<Training Phase>>

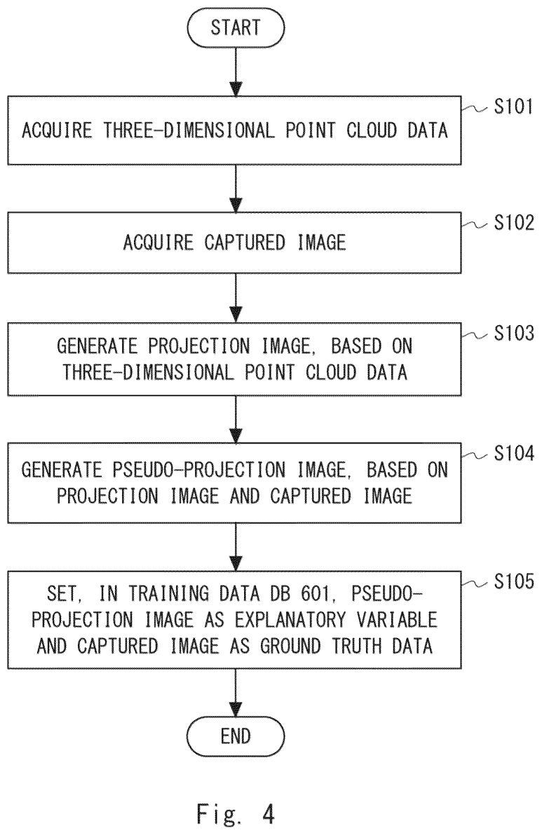

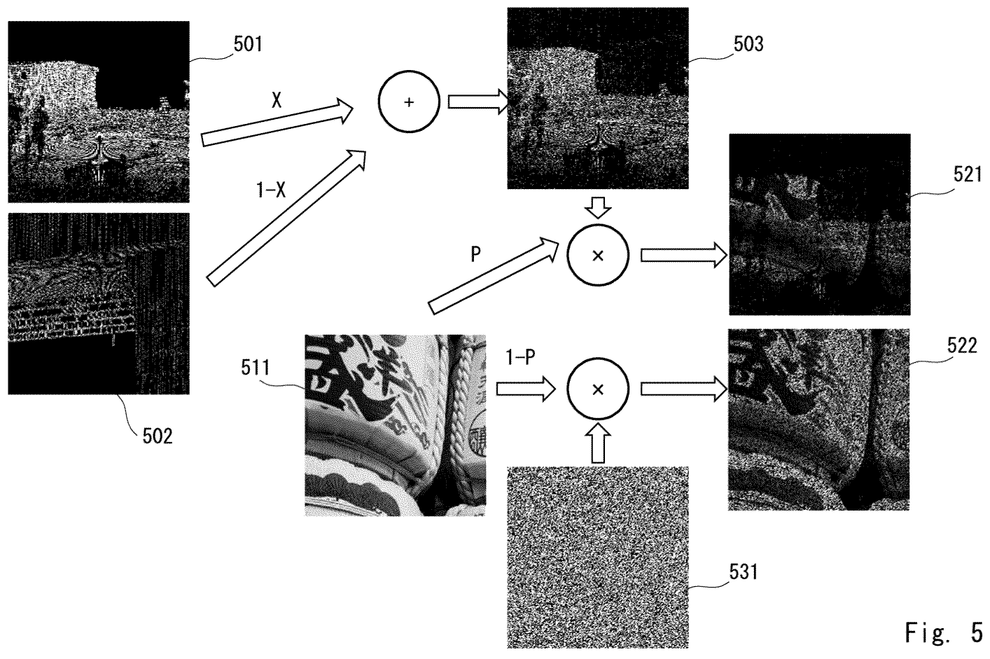

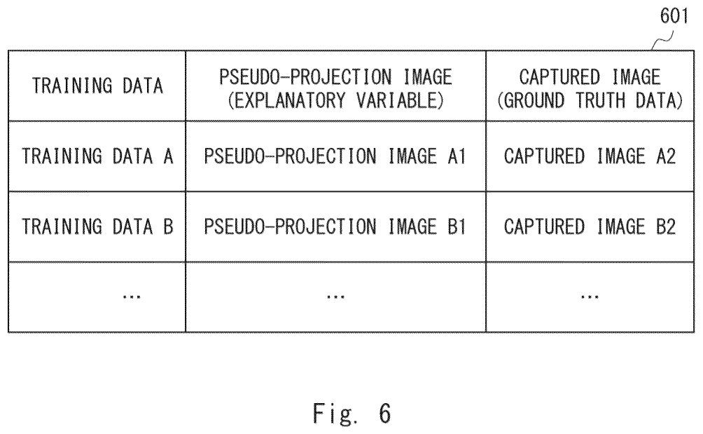

Next, one example of processing of generating training data of the information processing apparatus 10 according to the example embodiments is described with reference to FIG. 4 to FIG. 6. FIG. 4 is a flowchart illustrating one example of processing of generating training data of the information processing apparatus 10 according to the example embodiments. FIG. 5 is a diagram illustrating one example of processing of generating a pseudo-projection image of the information processing apparatus 10 according to the example embodiments. FIG. 6 is a diagram illustrating one example of a training data database (DB) 601 according to the example embodiments. Note that the information processing apparatus 10 may repeatedly execute the treatment of FIG. 4 a specific number of times (for example, 0.1 million times).

In step S101, the acquisition unit 11 acquires three-dimensional point cloud data. Herein, for example, the acquisition unit 11 may acquire one piece of three-dimensional point cloud data randomly selected from a DB in which a plurality of pieces of three-dimensional point cloud data are recorded.

The three-dimensional point cloud data may be acquired by using, for example, light detection and ranging (LiDAR), a stereo camera, a laser scanner, a 3D scanner, or the like. The three-dimensional point cloud data may include, for example, a three-dimensional position (coordinate information) of each point on the surface of the object. The three-dimensional point cloud data may include color information of each point.

Subsequently, the acquisition unit 11 acquires the captured image captured under the first imaging condition by the imaging apparatus (camera) (step S102). The first imaging condition may include, for example, conditions such as imaging position and direction. Herein, for example, the acquisition unit 11 may acquire one captured image randomly selected from a DB in which a plurality of captured images are recorded. The captured image may be an image of any subject captured under any imaging condition.

Examples of the captured image may include, for example, a photograph taken by a camera, a panoramic photograph taken by an omnidirectional camera, a still image cut out from a moving image, and an image generated by simulation using a 3DCG technique. Examples of the captured image may include, for example, a generated image generated by a known technique that automatically generates an image that looks similar to a photograph, an image (hyperspectral image) captured by a hyperspectral camera that spectrally captures light for each wavelength, an image (thermal image) captured by a thermal camera that can visualize a temperature, based on an amount of infrared rays emitted from an object, and the like.

Subsequently, based on the three-dimensional point cloud data acquired by the acquisition unit 11, the generation unit 12 generates a projection image under a second imaging condition being different from the first imaging condition (step S103). The second imaging condition may include conditions such as projection position and direction. The combination of the position and the direction included in the first imaging condition is different from the combination of the position and the direction included in the second imaging condition.

Herein, for example, the generation unit 12 may set each of the number of pixels in the vertical direction and the number of pixels in the horizontal direction of the projection image to be the same as each of the number of pixels in the vertical direction and the number of pixels in the horizontal direction of the captured image.

Then, the generation unit 12 may generate a projection image by, for example, perspective projection in which a three-dimensional object is projected in such a way as to converge at one point. Further, the generation unit 12 may generate a projection image by, for example, orthographic projection (parallel projection) in which a three-dimensional object is parallelly projected directly two-dimensionally.

The generation unit 12 may generate a projection image in a binary image composed of pixels including only white (pixel value is 1) and black (pixel value is 0). In such a case, for example, the generation unit 12 may set the pixel value of a specific pixel on the projection image to white, only when the three-dimensional point cloud data of the subject exist in a direction related to the specific pixel from the position of the camera (i.e., when the line-of-sight direction collides with a point in the three-dimensional point cloud data).

Further, as illustrated in FIG. 5, the generation unit 12 may generate a plurality (two or more) of projection images 501 and 502 having different imaging conditions (projection conditions), based on the one or more pieces of three-dimensional point cloud data acquired by the acquisition unit 11. Then, as illustrated in FIG. 5, the generation unit 12 may generate one projection image 503, based on the projection image 501 and the projection image 502. Thus, a more random projection image can be generated. FIG. 5 illustrates one example of processing of generating a pseudo-projection image of the information processing apparatus 10 according to the example embodiments. In the example of FIG. 5, the generation unit 12 generates the projection image 501 from a certain point and in a certain direction, and generates the projection image 502 from a point and/or in a direction being different from that of the projection image 501. Then, the generation unit 12 generates, for example, the projection image 503 acquired by extracting and combining ratio X of each pixel among the pixels of the projection image 501 and ratio 1-X of each pixel among the pixels of the projection image 502. As a result, the projection image 503 in which ratio X of the pixels among the pixels in the projection image 501 are replaced with the pixels in the projection image 502 is generated.

Subsequently, the generation unit 12 generates a pseudo-projection image, based on the projection image and the captured image acquired by the acquisition unit 11 (step S104). Herein, for example, the generation unit 12 may set the value of a pixel (for example, a white pixel) in which three-dimensional point cloud data of a subject exist in a direction related to a specific pixel on the projection image from the position of the camera, among the pixels in the projection image, to 1. The generation unit 12 may generate the pseudo-projection image by, for example, a logical conjunction (AND operation) of each pixel value in the projection image and each pixel value in the captured image. This makes it possible to generate a pseudo-projection image that looks like a projection image based on three-dimensional point cloud data, at a point and a direction in which a captured image is captured. In such a case, for example, the generation unit 12 may use the logical conjunction of the pixel value of each coordinate in the projection image and the pixel value of each associated coordinate (for example, having the same coordinates) in the captured image, as the pixel value of each associated coordinate in the pseudo-projection image. As a result, a pseudo-projection image is generated in which the value of each pixel of the captured image is black (pixel value is 0) when the value of each associated pixel in the projection image is black (pixel value is 0).

In the example of FIG. 5, the generation unit 12 generates a pseudo-projection image 521, based on the projection image 503 and a captured image 511 with a specific probability p (p is a value in a range of 0 to 1), and generates a pseudo-projection image 522, based on a random noise image 531 and the captured image 511 with the remaining probability (1-p) of the specific probability. In the example of FIG. 5, the generation unit 12 generates the pseudo-projection image 521, based on the logical conjunction of each pixel value of the captured image 511 and each pixel value of the projection image 503 with the specific probability p. In the example of FIG. 5, the generation unit 12 generates the pseudo-projection image 522, based on the logical conjunction of each pixel value of the captured image 511 and each pixel value of the random noise image 531 with the remaining probability (1-p) of the specific probability. Thus, a more random pseudo-projection image can be generated. Therefore, it is expected to improve the performance of the inference based on the learning result of the machine learning.

Note that the generation unit 12 may generate only the pseudo-projection image 521 by assuming that p=1. Further, the generation unit 12 may generate both the pseudo-projection image 521 and the pseudo-projection image 522. In such a case, for example, the number of pieces of training data can be increased.

The generation unit 12 may change (determine) the value of the specific probability p in accordance with the progress (for example, the number of epochs or the number of times of learning) of supervised learning. In such a case, for example, the generation unit 12 may increase the value of the specific probability p as the learning progresses. Thus, for example, it is possible to perform learning in such a way that knowledge acquired in a domain (for example, in a city) of the normally captured image 511 is corrected to a domain (for example, a specific facility) of the projection image 501 and the projection image 502. In such a case, for example, the generation unit 12 may change the value of the specific probability p in such a way that the value of the specific probability p approaches 0 in the initial stage of the learning, and the value of the specific probability p approaches 1 in the final stage of the learning.

Further, the generation unit 12 may change (determine) the value of the ratio X in accordance with the progress (for example, the number of epochs or the number of times of learning) of the learning. In such a case, for example, the generation unit 12 may increase the value of the ratio X as the learning progresses. Thus, for example, it is possible to perform learning in such a way that knowledge acquired in a wider domain is corrected to a domain (for example, a specific facility) of the projection image 501. In such a case, for example, the generation unit 12 may change the value of the ratio X in such a way that the value of the ratio X approaches 0 in the initial stage of the learning and the value of the ratio X approaches 1 in the final stage of the learning.

Further, for example, the generation unit 12 may determine (generate) the random noise image 531 in such a way that the ratio of the pixels that are black (pixel value is 0) increases as the learning progresses. Thus, for example, the random noise image 531 having a large ratio of a white color (pixel value is 1) is generated in such a way that the ratio of holding the information of the original captured image 511 is relatively large in the first half of the learning. Further, for example, the random noise image 531 having a large ratio of a black color (pixel value is 0) is generated in such a way that the ratio of missing information of the original captured image 511 is relatively large in the second half of the learning. Therefore, for example, even when a sparse (having a relatively large proportion of black pixels) projection image is input in the inference phase, it is possible to perform learning in such a way that the captured image can be appropriately inferred.

Further, for example, in a case where data of a combination of a projection image 501 and a captured image 511 captured (generated) under the same imaging condition can be acquired, the generation unit 12 may use the data of the combination at the end of the learning, and may relatively increase (for example, to a value close to 1) the value of at least one of the ratio X and the specific probability p. In such a case, the calculated pseudo-projection image 521 is similar to a projection image in a case where a three-dimensional object is captured under the same imaging conditions as the captured image. Therefore, fine tuning can be performed in which the machine learning result is finely adjusted to a specific task.

Note that, the data of the combination of the projection image 501 and the captured image 511 captured (generated) under the same imaging condition can be acquired by using, for example, a sensor, such as a stereo camera, that can simultaneously acquire the color and the like and the structure of a three-dimensional object. In a case where three-dimensional data of the subject of the captured image are present, the generation unit 12 may calculate the imaging condition of the captured image, based on the three-dimensional data by using, for example, a technique such as visual localization. Then, for example, the generation unit 12 may generate a projection image with the same imaging information as the captured image, based on the calculated imaging condition and the three-dimensional data.

Subsequently, the setting unit 13 sets (records), in the training data DB 601, learning data for performing supervised learning using the pseudo-projection image as an explanatory variable and the captured image acquired by the acquisition unit 11 as ground truth data (step S105). Thus, for example, the trained model can be trained in such a way that the representation of the projection image is similar to the representation of the captured image.

In the example of FIG. 6, a plurality of records of the combination of the pseudo-projection image and the captured image are recorded in the training data DB 601 in association with training data IDs. The training data ID is identification information of training data being a combination of a pseudo-projection image and a captured image.

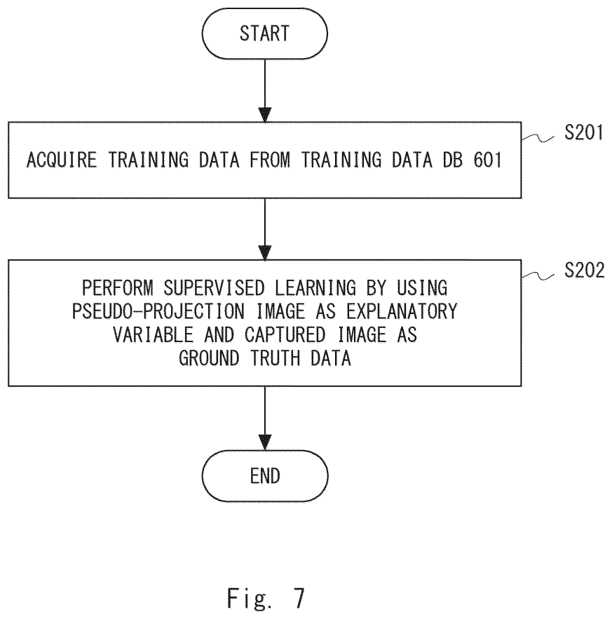

Next, one example of processing of generating a trained model of the information processing apparatus 10 according to the example embodiments is described with reference to FIG. 7. FIG. 7 is a flowchart illustrating one example of processing of generating a trained model of the information processing apparatus 10 according to the example embodiments.

In step S201, the acquisition unit 11 acquires the data set of the learning data from the training data DB 601.

Subsequently, the generation unit 12 generates a trained model for inferring the captured image from the projection image, by performing supervised learning using the pseudo-projection image as an explanatory variable and using the captured image as ground truth data, for each record in the training data DB 601 (step S202). Herein, for example, the generation unit 12 may calculate a loss indicating a low degree of similarity between the captured image being the ground truth data and a captured image generated by inference from the pseudo-projection image. The loss may be, for example, an average value of a difference between each pixel value in one image and each pixel value in the other image, or the like. Further, the loss may be, for example, a loss (perceptual loss) between feature maps acquired by inputting each image into a specific deep learning model, or the like. Then, the generation unit 12 may perform machine learning in such a way as to reduce the loss, for example.

Further, the generation unit 12 may perform machine learning by using, for example, a generative adversarial network (GAN). In such a case, the generation unit 12 may use, for example, a deep convolutional GAN (DCGAN) using a convolutional neural network (CNN) for two networks, i.e., a generation network (generator) and a discrimination network (discriminator).

### <<Inference Phase>>

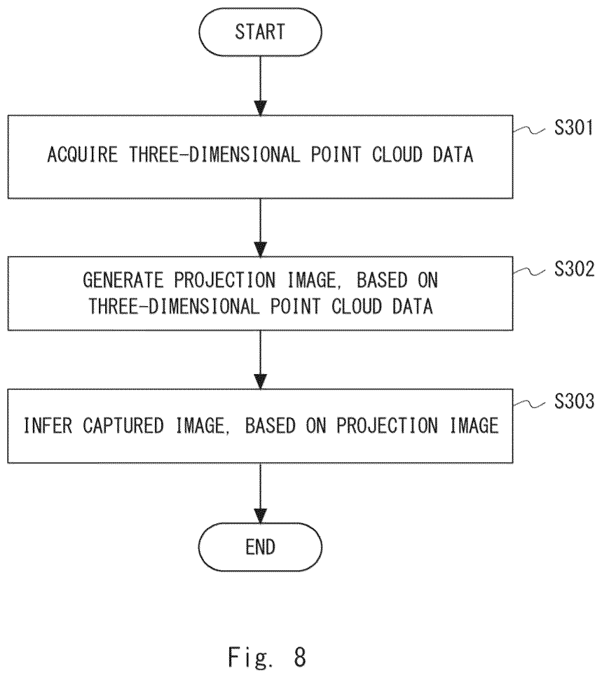

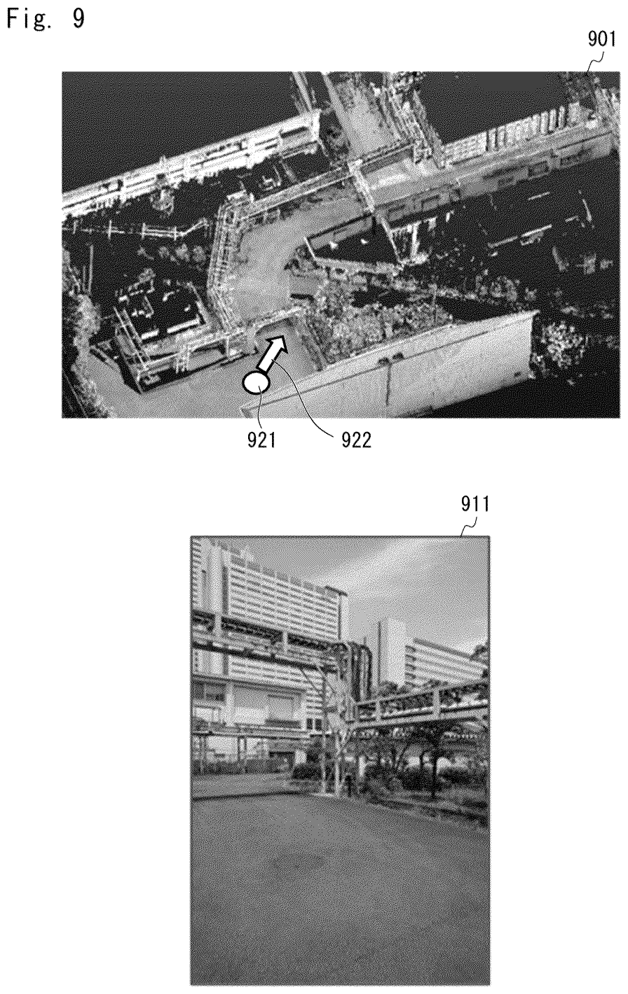

Next, one example of processing of an inference phase of the information processing apparatus 20 according to the example embodiments is described with reference to FIG. 8 and FIG. 9. FIG. 8 is a flowchart illustrating one example of processing of an inference phase of the information processing apparatus 20 according to the example embodiments. FIG. 9 is a diagram illustrating one example of an application using an inference result according to the example embodiments.

In step S301, the acquisition unit 21 acquires three-dimensional point cloud data. Herein, for example, the acquisition unit 11 may acquire three-dimensional point cloud data relating to a specific facility from a database (DB) in which a plurality of pieces of three-dimensional point cloud data are recorded.

Subsequently, the generation unit 22 generates a projection image in a randomly determined point and direction, based on the three-dimensional point cloud data acquired by the acquisition unit 11 (step S302). Note that the method for generating the projection image may be similar to that of the processing of step S103 in FIG. 4.

Subsequently, the inference unit 23 infers a captured image, based on the projection image generated by the generation unit 22, by using the trained model generated in the processing of FIG. 7 (step S303). Thus, based on the three-dimensional point cloud data, a captured image in the point and direction determined in the processing of step S302 can be generated.

Note that, the inference unit 23 may determine the position and orientation of the imaging apparatus at the time of image capturing, for example, by performing feature matching between each captured image inferred for each point and each direction and the captured image actually captured by the imaging apparatus. In the example of FIG. 9, one example of three-dimensional point cloud data 901 of a specific facility and a captured image 911 actually captured by the imaging apparatus are illustrated. In the example of FIG. 9, the inference unit 23 determines the position 321 and the orientation 322 of the imaging apparatus at the time of image capturing.

Further, the inference unit 23 may determine the position of the subject in the captured image by, for example, performing feature matching between each captured image inferred for each point and each direction and a captured image actually captured by the imaging apparatus.

### <Others>

A case where a trained model for generating (inferring) a captured image (photograph) from three-dimensional point cloud data is generated by supervised learning is studied. In such a case, in the learning, a large amount of learning data sets being a combination of a projection image and a captured image being ground truth data are required. However, it is not easy to prepare such data sets. Meanwhile, according to the present disclosure, it is possible to generate a large number of supervised learning data sets, based on any captured image and any piece of three-dimensional point cloud data. Therefore, it is possible to appropriately generate (infer) the captured image from the projection image.

### Modified Example

Each of the information processing apparatus 10 and the information processing apparatus 20 may be an apparatus included in one housing, but the information processing apparatus of the present disclosure is not limited thereto. Each unit of the information processing apparatus 10 and each unit of the information processing apparatus 20 may be achieved by, for example, cloud computing constituted by one or more computers. Further, the information processing apparatus 10 and the information processing apparatus 20 may be the same information processing apparatus. Such an information processing apparatus 10 is also included as one example of an “information processing apparatus” according to the present disclosure.

Although the present disclosure has been described with reference to the example embodiments, the present disclosure is not limited to the above-described example embodiments. Various changes that can be understood by a person skilled in the art within the scope of the present disclosure can be made to the configuration and details of the present disclosure. Each example embodiment can be combined with other example embodiments as appropriate.

The present disclosure is not limited to the above-described example embodiments, and can be appropriately modified without departing from the spirit.

An example advantage according to the above-described embodiments is to appropriately generate an image to be captured by a camera from a projection image.

Some or all of the above-described example embodiments may be described as the following supplementary notes, but are not limited thereto. It should be noted that some or all of the elements (e.g., configurations and functions) described in each of the supplementary notes dependent on supplementary note 1 may be dependent on independent supplementary notes of other categories by similar dependencies. Some or all of the elements described in any supplementary note may be applied to various hardware, software, recording means for recording software, systems, and methods.

### (Supplementary Note 1)

An information processing apparatus including:
an acquisition unit configured to acquire three-dimensional point cloud data and a captured image captured by an imaging apparatus under a first imaging condition;
a generation unit configured to generate a projection image under a second imaging condition being different from the first imaging condition, based on the three-dimensional point cloud data, and generate a pseudo-projection image, based on the projection image and the captured image; and
a setting unit configured to set learning data for performing supervised learning by using the pseudo-projection image as an explanatory variable and using the captured image as ground truth data.

### (Supplementary Note 2)

The information processing apparatus according to supplementary note 1, wherein a combination of a position and a direction included in the first imaging condition is different from a combination of a position and a direction included in the second imaging condition.

### (Supplementary Note 3)

The information processing apparatus according to supplementary note 1 or 2, wherein
the projection image includes a plurality of projection images, and
the generation unit generates the plurality of projection images having different imaging conditions, based on the three-dimensional point cloud data, and generates the pseudo-projection image, based on the plurality of projection images and the captured image.

### (Supplementary Note 4)

The information processing apparatus according to supplementary note 3, wherein the generation unit
generates a first projection image and a second projection image each having a different imaging condition, based on the three-dimensional point cloud data,
generates a third projection image in which a specific ratio of pixels among pixels in the first projection image is replaced with pixels in the second projection image, and
generates the pseudo-projection image, based on a logical conjunction of each pixel value of the third projection image and each pixel value of the captured image.

### (Supplementary Note 5)

The information processing apparatus according to supplementary note 1 or 2, wherein the generation unit
generates the pseudo-projection image, based on the projection image and the captured image, with a specific probability, and
generates the pseudo-projection image, based on a random noise image and the captured image, with a remaining probability of the specific probability.

### (Supplementary Note 6)

The information processing apparatus according to supplementary note 5, wherein the generation unit increases a value of the specific probability as the supervised learning progresses.

### (Supplementary Note 7)

The information processing apparatus according to supplementary note 1 or 2, wherein the generation unit performs supervised learning, based on the learning data, and generates a trained model that infers a captured image from a projection image.

### (Supplementary Note 8)

An information processing method including:
acquiring three-dimensional point cloud data and a captured image captured by an imaging apparatus under a first imaging condition;
generating a projection image under a second imaging condition, based on the three-dimensional point cloud data, and generating a pseudo-projection image, based on the projection image and the captured image; and
setting learning data for performing supervised learning by using the pseudo-projection image as an explanatory variable and using the captured image as ground truth data.

### (Supplementary Note 9)

A program that causes a computer to execute processing of:
acquiring three-dimensional point cloud data and a captured image captured by an imaging apparatus under a first imaging condition;
generating a projection image under a second imaging condition, based on the three-dimensional point cloud data, and generating a pseudo-projection image, based on the projection image and the captured image; and
setting learning data for performing supervised learning by using the pseudo-projection image as an explanatory variable and using the captured image as ground truth data.

### (Supplementary Note 10)

An information processing apparatus including:
an acquisition unit configured to acquire first three-dimensional point cloud data;
a generation unit configured to generate a first projection image, based on the first three-dimensional point cloud data; and
an inference unit configured to infer a second captured image, based on the first projection image, by using a trained model generated by supervised learning using a pseudo-projection image being generated based on a first captured image captured by an imaging apparatus under a first imaging condition and a second projection image under a second imaging condition generated based on second three-dimensional point cloud data, as an explanatory variable, and using the first captured image as ground truth data.

While the present disclosure has been particularly shown and described with reference to example embodiments thereof, the present disclosure is not limited to these example embodiments. It will be understood by those of ordinary skill in the art that various changes in form and details may be made therein without departing from the sprit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. An information processing apparatus comprising:
at least one memory storing instructions; and
at least one processor configured to execute the instructions to
acquire three-dimensional point cloud data and a captured image captured by an imaging apparatus under a first imaging condition,
generate a projection image under a second imaging condition being different from the first imaging condition, based on the three-dimensional point cloud data, and generate a pseudo-projection image, based on the projection image and the captured image, and
set learning data for performing supervised learning by using the pseudo-projection image as an explanatory variable and using the captured image as ground truth data.

2. The information processing apparatus according to claim 1, wherein a combination of a position and a direction being included in the first imaging condition is different from a combination of a position and a direction being included in the second imaging condition.

3. The information processing apparatus according to claim 1, wherein
the projection image includes a plurality of projection images, and
the at least one processor is further configured to execute the instructions to generate the plurality of projection images having different imaging conditions, based on the three-dimensional point cloud data, and generate the pseudo-projection image, based on the plurality of projection images and the captured image.

4. The information processing apparatus according to claim 3, wherein the at least one processor is further configured to execute the instructions to:
generate a first projection image and a second projection image each having a different imaging condition, based on the three-dimensional point cloud data;
generate a third projection image in which a specific ratio of pixels among pixels in the first projection image is replaced with pixels in the second projection image; and
generate the pseudo-projection image, based on a logical conjunction of each pixel value of the third projection image and each pixel value of the captured image.

5. The information processing apparatus according to claim 1, wherein the at least one processor is further configured to execute the instructions to:
generate the pseudo-projection image, based on the projection image and the captured image, with a specific probability; and
generate the pseudo-projection image, based on a random noise image and the captured image, with a remaining probability of the specific probability.

6. The information processing apparatus according to claim 5, wherein the at least one processor is further configured to execute the instructions to increase a value of the specific probability as the supervised learning progresses.

7. The information processing apparatus according to claim 1, wherein the at least one processor is further configured to execute the instructions to perform supervised learning, based on the learning data, and generate a trained model that infers a captured image from a projection image.

8. An information processing method comprising:
acquiring three-dimensional point cloud data and a captured image captured by an imaging apparatus under a first imaging condition;
generating a projection image under a second imaging condition, based on the three-dimensional point cloud data, and generating a pseudo-projection image, based on the projection image and the captured image; and
setting learning data for performing supervised learning by using the pseudo-projection image as an explanatory variable and using the captured image as ground truth data.

9. An information processing apparatus comprising:
at least one memory storing instructions; and
at least one processor configured to execute the instructions to
acquire first three-dimensional point cloud data,
generate a first projection image, based on the first three-dimensional point cloud data, and
infer a second captured image, based on the first projection image, by using a trained model generated by supervised learning using a pseudo-projection image being generated based on a first captured image captured by an imaging apparatus under a first imaging condition and a second projection image under a second imaging condition generated based on second three-dimensional point cloud data, as an explanatory variable, and using the first captured image as ground truth data.
